(19) United States
(12) Patent Application Publication
(10) Pub. No.: US 2006/0217000 A1
(43) Pub. Date: Sep. 28, 2006

(54) Method for forming polymer materials utilizing modular die units

(75) Inventors: Jerry Zucker, Charleston, SC (US); James Schaeffer, Charleston, SC (US); Richard Ferencz, Isle of Palms, SC (US); James Snyder, Cary, NC (US); Tim Krause, Mooresville, NC (US); Nick Carter, Mooresville, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 11/435,414

(22) Filed: May 16, 2006

Related U.S. Application Data
(62) Division of application No. 10/819,698, filed on Apr. 7, 2004.
(60) Provisional application No. 60/462,054, filed on Apr. 11, 2003.

(51) Int. Cl. H01R 24/00

(52) U.S. Cl. 439/632

(57) ABSTRACT

The present invention is directed to a modular die unit comprising a plurality of individually shaped plates wherein the shaped plates are stacked in face to face juxtaposition, and when placed into such a juxtaposition exhibit useful polymer forming attributes heretofore unattainable by prior art practices. Single die plates are formed such that the plates exhibit a finite geometric relationship, which in turn provides resistance to flexural deformation of the individually shaped die plates and conversely, improved resistance to variability of the modular die unit and enhanced and predictable formation characteristics of the polymer material formed therewith. Each of said single die plates within the stack forming the modular die unit exhibit an x-direction, a y-direction, and a z-direction, wherein any one of said single die plates exhibit in said x-direction and y-direction to have at least a 50% planar continuity of the total planar continuity.

### CROSS-REFERENCE TO RELATED APPLICATION

This application is a division of U.S. Ser. No. 10/819,698, filed Apr. 7, 2004, which claims the benefit of priority Provisional Application No. 60/462,054, filed Apr. 11, 2003, the disclosures of which are incorporated herein by reference.

### TECHNICAL FIELD

The present invention is directed to the method of forming polymer materials, and specifically, the method of forming polymer materials by means of a stacked-plate modular die unit exhibiting resistance to flexural deformation and enhanced polymer formation capabilities.

### BACKGROUND OF THE INVENTION

Formation of polymeric compounds into a variety of geometries is well known in the art. For example, heretofore formation practices have exhibited particular importance in the fabrication of continuous filaments, fragmentary filaments and films from a variety of precursor polymer compositions. These practices have typically employed the use of a monolithic forming block, or die, to which the polymer composition or compositions are introduced. The polymer composition(s) are then expressed from the monolithic die under the influence of force, most typically such force being presented in the form of mechanical, hydraulic, or electrostatic attraction. Due to the physical conditions of the polymer composition, the mode of force, the physical parameters of the monolithic die, and the environment into which the polymer composition is expressed, polymer materials are formed having specific and pre-determined performance attributes.

Due to the nature of formation and use of monolithic dies themselves, such dies can pose a number of technical limitations. The uniform introduction of polymer composition into the monolithic die, combined with the maintenance of the polymer composition in an ideal expression state, has proved to be an extremely burdensome task as the dies used to obtain optimum commercial efficiencies must either be quite large in size and/or exhibit enhanced process robustness. Further, over the course of continuous use, monolithic dies are subject to wear, which in turn alters the physical parameters of the die and likewise, alters the resulting polymer materials formed thereof.

Attempts have been made to convert monolithic dies into forms that more readily support the replacement and/or modification of the forming elements thereof. U.S. Pat. No. 5,679,379 to Fabbricante et al., and U.S. Pat. No. 6,114,017 also to Fabbricante et al., teaches to a practice , whereby specially shaped plates are combined in a repeating series to create a sequence of readily and economically manufactured modular die units which are then contained in a die housing which is a frame or holding device that contains the modular plate structure and accommodates the design of the molten polymer and heated air inlets.

It has been found that such use of specially shaped plates combined into a modular die unit exhibit multiple deficiencies that compromise the ability of the modular die unit to perform in the manufacture of formed-polymer constructs. Devices as taught by Fabbricante et al., exhibit pronounced flexural deformation of the shaped plates when placed under thermal and pressure forces. This deformation results in variability in the polymer material formed not only across the width of a corresponding modular die unit comprising such shaped plates, but also variability over the course of time as the modular die unit is subjected to continuous stresses.

An unmet need exists for a modular or stacked-plate die unit comprising a plurality of individually shaped die plates wherein the individual die plates are formed such that flexural deformation is controlled and a modular die unit is rendered exhibiting commercial practicability, repeatability and robust and prolonged polymer formation performance.

### SUMMARY OF THE INVENTION

The present invention is directed to a modular die unit comprising a plurality of individually shaped plates wherein the shaped plates are stacked in face to face juxtaposition, and when placed into such a juxtaposition exhibit useful polymer forming attributes heretofore unattainable by prior art practices. Single die plates are formed such that the plates exhibit a finite geometric relationship, which in turn provides resistance to flexural deformation of the individually shaped die plates and conversely, improved resistance to variability of the modular die unit and enhanced and predictable formation characteristics of the polymer material formed therewith. Each of said single die plates within the stack forming the modular die unit exhibit an x-direction, a y-direction, and a z-direction, wherein any one of said single die plates exhibit in said x-direction and y-direction to have at least a 50% planar continuity of the total planar continuity.

The flexural deformation attributes of the individually shaped die plates is also improved over the prior art practices by controlling the amount of component geometry through the depth of the die plate wherein each of said single die plates within the stack having an x-direction, a y-direction, and a z-direction, said single die plates exhibit in said z-direction of the single die plates within the stack are planar in formation and designed in the z-direction to have at least 20% depth continuity of the total planar depth continuity at any given axis in the z-direction

The flexural deformation attributes of the individually shaped die plates are, optionally, further combined with finite control of the fluidic passage-ways defined in the component geometry of the die plate to further enhance the performance of the corresponding modular die unit when forming polymer materials. So as to obtain effective interfacing of two or more fluidic passageways, said fluid passage ways should interface at coinciding incident angles of between 3 and 87 degrees.

Due to the acute improvement in resistance to flexural deformation of the individually shaped die plates, much more aggressive fluid passageway geometries can be explored. Die plates formed in accordance with the present invention can exhibit fluid passageways having length to diameter ratios of greater than 10 to 1 can be formed readily, with 50 to 1 and 100 to 1 ratios being attainable.

It is within the purview of the present invention that individually shaped die plates can comprise surface asperities, projections, voids and other deviations in planar geometry which allow for the shaped plates to adjust into specific relative orientation when one or more of such plates are placed into face to face juxtaposition.

It is further within the purview of the present invention that suitable means for combining the individually shaped die plates into a modular die unit can include those selected from the group consisting of internal devices which extend through specified voids commonly defined in the die plates, external devices which cooperate with channels or other such key-ways commonly defined in the die plates, external devices which extend about one or more surfaces defined by the stack of die plates, and the combinations thereof. The overall shape or geometry of the modular die unit formed by the combination of two or more individually shaped die plates is not a limitation of the present invention, and as such, can include rectilinear, circular, cubic, rhombic, trapezoidal, cuboidal, conical, frustruconical, and forms wherein regions of the modular die unit combine one or more of the aforementioned geometries.

The fluidic passageways defined in the combination of one or more individually shaped die plates can be employed in the expression of one or more fluidic, semi-fluidic, or other such compounds and agents as can be rendered fluidic through application of heat and/or pressure, as well as particulates, colloidal suspensions, finite staple length natural and/or synthetic fibers, foams and gels. Suitable exemplary compounds that are rendered fluidic by application of heat include those polymers chosen from the group of thermoplastic polymers consisting of polyolefins, polyamides, and polyesters, wherein the polyolefins are chosen from the group consisting of polypropylene, polyethylene, and the combination and modifications thereof.

Depending upon the fluid passageways defined in the individually shaped die plates, and the commonly defined geometries created by the combination of the individually shaped die plates in the modular die unit, numerous and varied polymer materials can be formed. Continuous filamentous polymer materials can be formed by defining a repeating pattern of distinct orifices in the modular die unit. By further including one or more fluidic passageways coincident with the distinct orifice, wherein a pressurized gas is expressed upon the orifice, finer filamentous fiber forms can be formed, including those fiber forms having a diameter of less than about 1 micron. In the combination or alternative, various solvents and other fluid chemistries can be co-expressed, such as taught by Shah et al., U.S. Pat. No. 5,279,776, incorporated herein by reference. Should a finite thickness film material be desired, a common fluidic passageway can be defined by the stack of individually shaped such that the same or different polymeric materials are expressed in a transversely oriented fashion. Due to ability to specifically order the individually shaped die plates within the modular die unit, complex expression patterns can be described, including one or more continuous filaments, fragmentary filaments, and/or films having the same or differing polymer or polymer composition, shape, diameter, thickness and relative lay down orientation. Further, one or the formed polymeric material or materials may comprise homogeneous, bi-component, and/or multi-component profiles, performance modifying additives or agents, aesthetic modifying additives or agents, and the blends thereof.

Other features and advantages of the present invention will become readily apparent from the following detailed description, the accompanying drawings, and the appended claims.

### BRIEF DESCRIPTION OF THE DRAWINGS

FIG. 1 is a diagrammatic representation of a die plate of the present invention;

FIG. 2 is a diagrammatic representation of the FIG. 1 die plate demonstrating air extrusion path and polymer extrusion path;

FIG. 3 is a diagrammatic representation of FIG. 1 die plate in a modular die;

FIG. 4 is a diagrammatic representation of a die plate of the present invention;

FIG. 5 is a diagrammatic representation of a die plate of the present invention;

FIG. 6 is a representative die plate of the present invention demonstrating the planar continuity;

FIG. 7 is a close up view of the FIG. 6 die plate further demonstrating the planar continuity; and

FIGS. 8a, 8b, and 8c respectively, illustrate percent continuity of depth, percent planar continuity, x-dimension, and percent planar continuity, y-dimension.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

The present invention is directed to a modular die unit comprising a plurality of individually shaped plates wherein the shaped plates are stacked in face to face juxtaposition, and when placed into such a juxtaposition exhibit useful polymer forming attributes heretofore unattainable by prior art practices. The single die plates may be held in place by compression tensioning, such as an external clamping force or an internal drawing force. It is also contemplated that a vacuum slot be positioned within the stack-plate die. Further, the single plates may be aligned and held precisely in place by guide elements. Such guide elements may be provided as alignment holes in one or more single die plates or projections extending from one or more single die plates. The alignment holes or guide holes of the single die plates may also be threaded onto cooled rods.

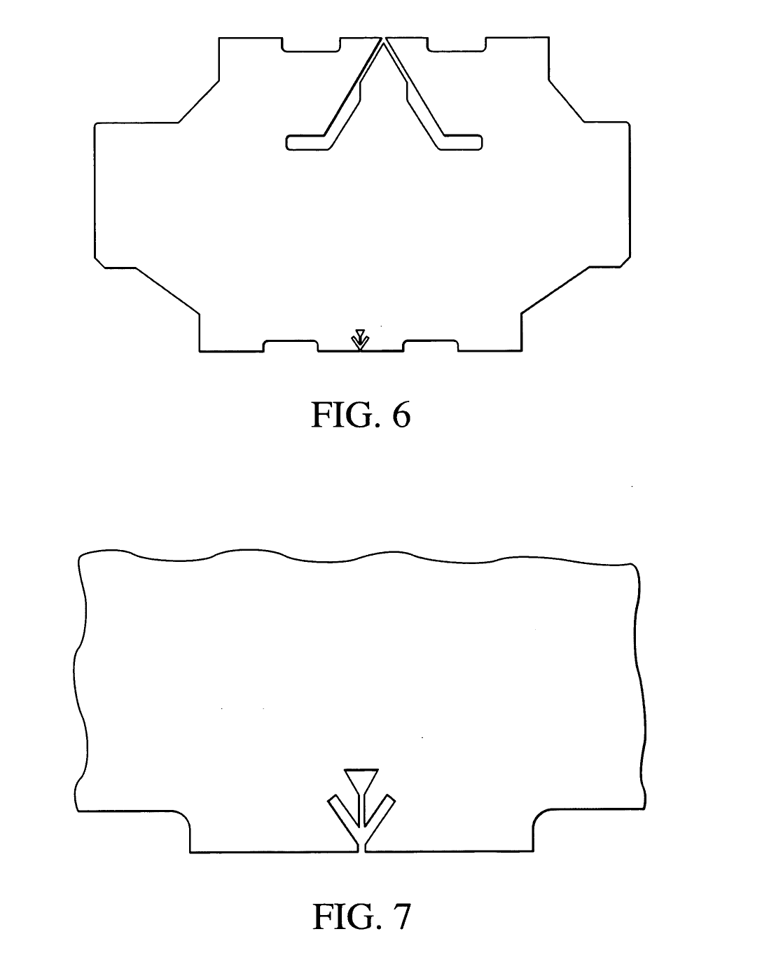

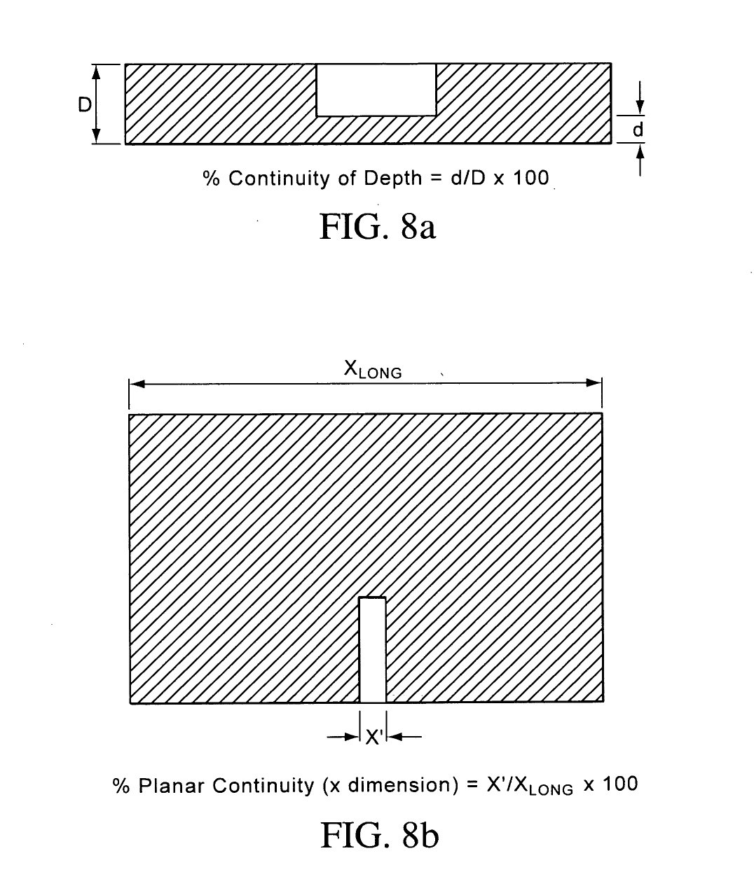

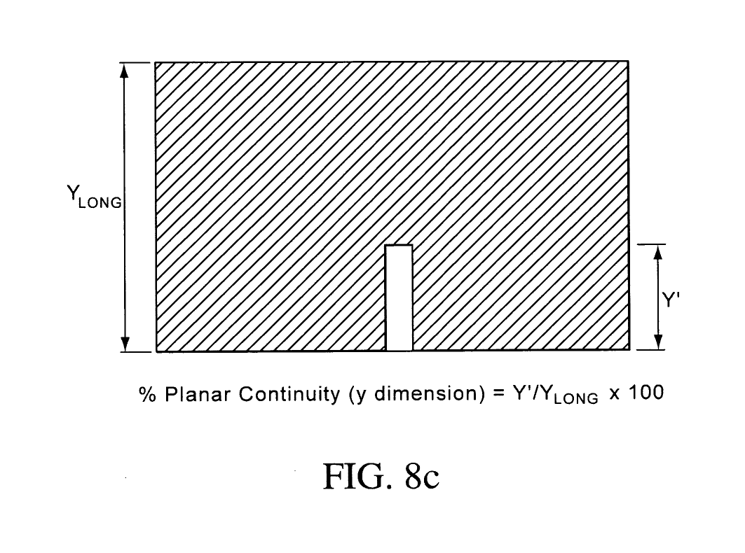

Single die plates are formed such that the plates exhibit a finite geometric relationship, which in turn provides resistance to flexural deformation of the individually shaped die plates and conversely, improved resistance to variability of the modular die unit and enhanced and predictable formation characteristics of the polymer material formed therewith. Each of said single die plates within the stack forming the modular die unit exhibit an x-direction, a y-direction, and a z-direction, wherein any one of said single die plates exhibit in said x-direction and y-direction to have at least a 50% planar continuity of the total planar continuity. Referencing FIGS. 6 and 7 therein is shown a representative die plate with such planar continuity.

The flexural deformation attributes of the individually shaped die plates is also improved over the prior art practices by controlling the amount of component geometry through the depth of the die plate wherein each of said single die plates within the stack having an x-direction, a y-direction, and a z-direction, said single die plates exhibit in said z-direction of the single die plates within the stack are planar in formation and designed in the z-direction to have at least 20% depth continuity of the total planar depth continuity at any given axis in the z-direction.

The flexural deformation attributes of the individually shaped die plates are, optionally, further combined with finite control of the fluidic passage-ways defined in the component geometry of the die plate to further enhance the performance of the corresponding modular die unit when forming polymer materials. So as to obtain effective interfacing of two or more fluidic passageways, said fluid passage ways should interface at coinciding incident angles of between 3 and 87 degrees.

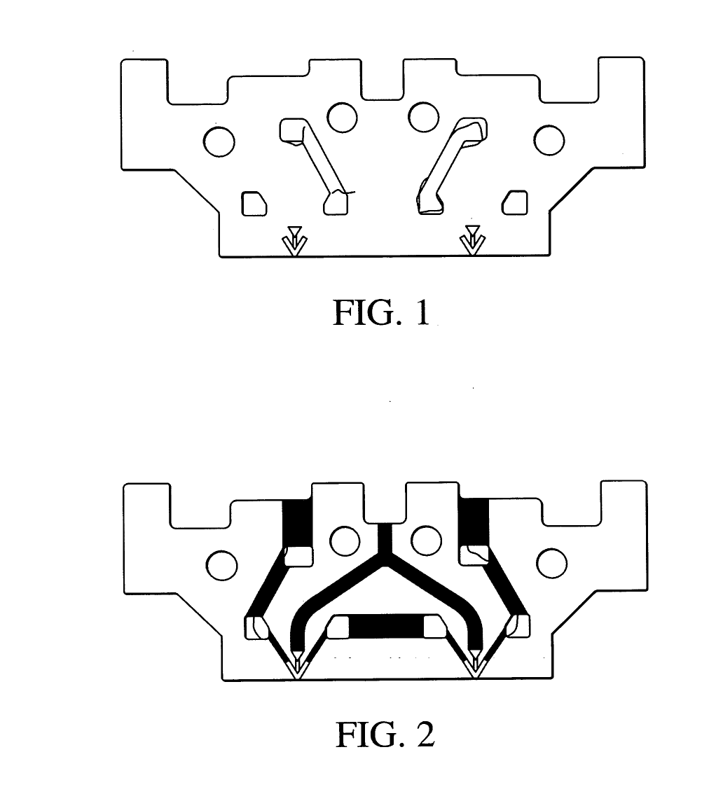

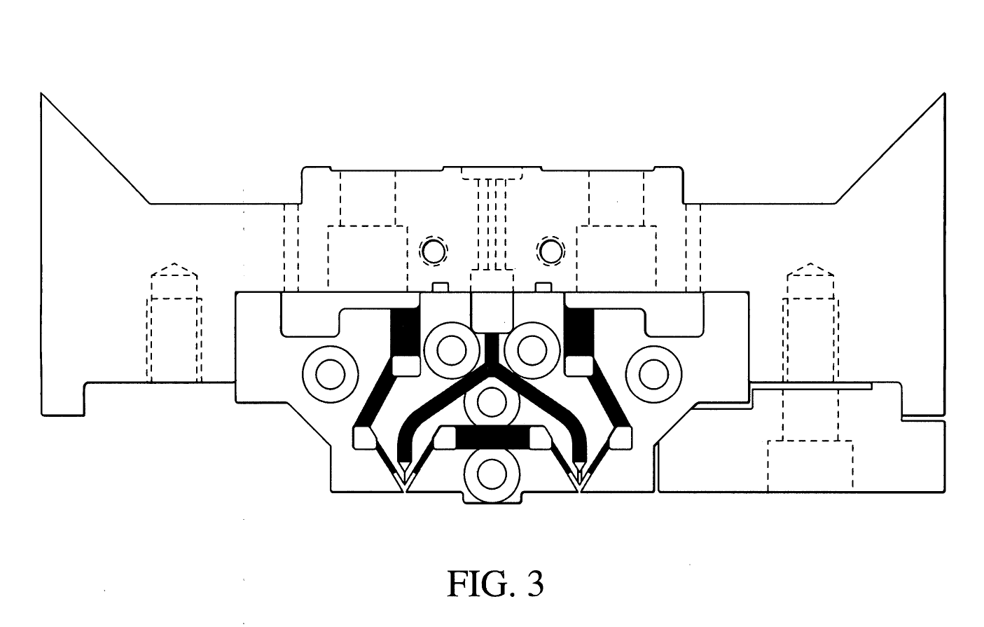

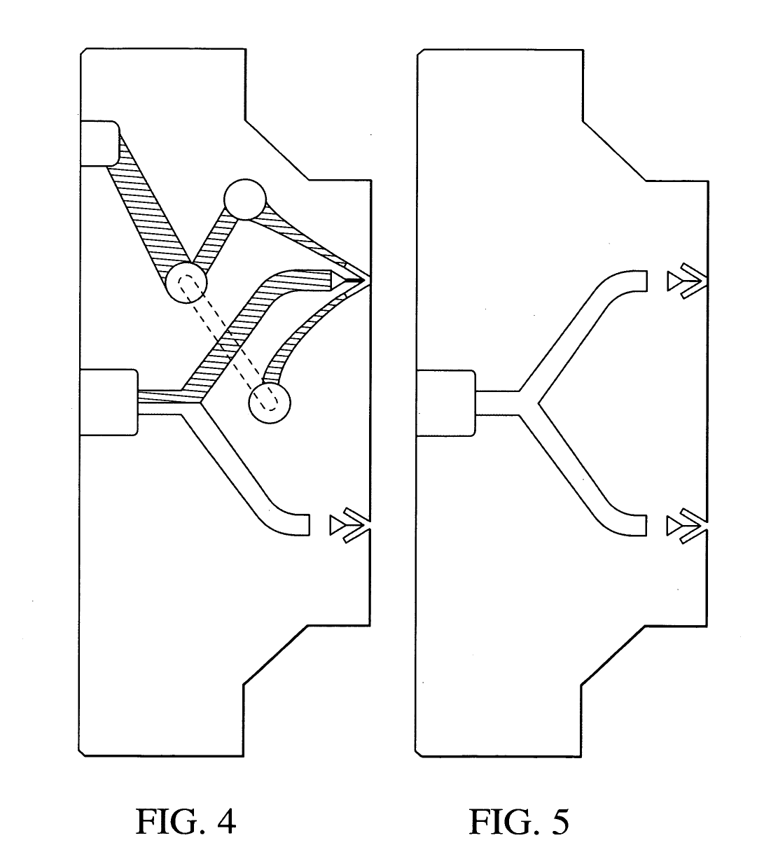

Due to the acute improvement in resistance to flexural deformation of the individually shaped die plates, much more aggressive fluid passageway geometries can be explored. Die plates formed in accordance with the present invention can exhibit fluid passageways having length to diameter ratios of greater than 10 to 1 can be formed readily, with 50 to 1 and 100 to 1 ratios being attainable. In reference to FIGS. 1-3, FIG. 1 shows a diagrammatic representation of a die plate of the present invention. FIG. 2 demonstrates the air and polymer extrusion paths, while FIG. 3 shows a diagrammatic representation of the die plate within a modular die.

It is within the purview of the present invention that individually shaped die plates can comprise surface asperities, projections, voids and other deviations in planar geometry which allow for the shaped plates to adjust into specific relative orientation when one or more of such plates are placed into face to face juxtaposition.

It is further within the purview of the present invention that suitable means for combining the individually shaped die plates into a modular die unit can include those selected from the group consisting of internal devices which extend through specified voids commonly defined in the die plates, external devices which cooperate with channels or other such key-ways commonly defined in the die plates, external devices which extend about one or more surfaces defined by the stack of die plates, and the combinations thereof. The overall shape or geometry of the modular die unit formed by the combination of two or more individually shaped die plates is not a limitation of the present invention, and as such, can include rectilinear, circular, cubic, rhombic, trapezoidal, cuboidal, conical, frustruconical, and forms wherein regions of the modular die unit combine one or more of the aforementioned geometries.

The chemical composition of the individually shaped plates is not of limitation to the practice of the present invention, and as such may include ferrous, nonferrous, alloy, polymeric, of either homogenous, laminate or composite construction. Modular dies comprising a plurality of individually shaped plates may comprise of such plates being of the same or different chemical composition. Channel, key-ways, extrusion gaps and other geometric forms in the individually shaped plates can be created by suitable including, but not limited to: direct casting, mechanical processing, ablation, electrostatic discharge, and/or chemical etching.

The fluidic passageways defined in the combination of one or more individually shaped die plates can be employed in the expression of one or more fluidic, semi-fluidic, or other such compounds and agents as can be rendered fluidic through application of heat and/or pressure, as well as particulates, colloidal suspensions, finite staple length natural and/or synthetic fibers, foams and gels. Suitable exemplary compounds that are rendered fluidic by application of heat include those polymers chosen from the group of thermoplastic polymers consisting of polyolefins, polyamides, and polyesters, wherein the polyolefins are chosen from the group consisting of polypropylene, polyethylene, and the combination and modifications thereof.

Depending upon the fluid passageways defined in the individually shaped die plates, and the commonly defined geometries created by the combination of the individually shaped die plates in the modular die unit, numerous and varied polymer materials can be formed. Continuous filamentous polymer materials can be formed by defining a repeating pattern of distinct orifices in the modular die unit. By further including one or more fluidic passageways coincident with the distinct orifice, wherein a pressurized gas is expressed upon the orifice, finer filamentous fiber forms can be formed, including those fiber forms having a diameter of less than about 1 micron. In the combination or alternative, various solvents and other fluid chemistries can be co-expressed, such as taught by Shah et al., U.S. Pat. No. 5,279,776, incorporated herein by reference. Should a finite thickness film material be desired, a common fluidic passageway can be defined by the stack of individually shaped such that the same or different polymeric materials are expressed in a transversely oriented fashion. Due to ability to specifically order the individually shaped die plates within the modular die unit, complex expression patterns can be described, including one or more continuous filaments, fragmentary filaments, and/or films having the same or differing polymer or polymer composition, shape, diameter, thickness and relative lay down orientation. Further, one or the formed polymeric material or materials may comprise homogeneous, bi-component, and/or multi-component profiles, performance modifying additives or agents, aesthetic modifying additives or agents, and the blends thereof.

Technologies capable of utilizing or otherwise incorporating modular die units of the present invention include such examples as those which form continuous filament nonwoven fabrics, staple fiber nonwoven fabrics, continuous filament or staple fiber woven textiles (to include knits), and films. These technologies can utilize fluidic passageways defined in the combination of one or more individually shaped die plates comprising the modular die unit. The fluidic passageways can be employed in the expression of one or more fluidic, semi-fluidic, (or other such compounds and agents as can be rendered fluidic through application of heat and/or pressure) as well as particulates, colloidal suspensions, finite staple length natural and/or synthetic fibers, foams and gels. Fibers and/or filaments formed from a modular die in accordance with the present invention are selected from natural or synthetic composition, of homogeneous or mixed fiber length. Optionally, the shaped die plates can in combination simultaneously form one or more common extrusion gaps, and one or more continuous filament and/or fragmentary filament extrusion orifices. Suitable natural fibers include, but are not limited to, cotton, wood pulp and viscose rayon. Synthetic fibers, which may be blended in whole or part, include thermoplastic and thermoset polymers. Thermoplastic polymers suitable for use in the modular die include polyolefins, polyamides and polyesters. The thermoplastic polymers may be further selected from homopolymers; copolymers, conjugates and other derivatives including those thermoplastic polymers having incorporated melt additives or surface-active agents.

In general, continuous filament nonwoven fabric formation involves the practice of the spunbond process as described in U.S. Pat. No. 4,041,203, incorporated herein by reference. A spunbond process involves supplying a molten polymer, which is then extruded under pressure through a large number of orifices. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one die is used in line for the purpose of forming a multi-layered fabric, the subsequent webs are collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

A related means to the spunbond process for forming a layer of a nonwoven fabric is the meltblown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,041,203. The meltblown process, as well as the cross-sectional profile of the spunbond filament or meltblown microfiber, is not a critical limitation to the practice of the present invention.

It is within the purview of the present invention that a nonwoven material can be formed wherein the filaments exhibit a cross-dimensional measure of less than 1.0 micron, hereinafter referred to as nano-denier fibers and filaments. Suitable nano-denier continuous filament layers can be formed by either direct spinning of nano-denier filaments or by formation of a multi-component filament that is subsequently divided into nano-denier filaments prior to deposition. U.S. Pat. No. 5,678,379 and U.S. Pat. No. 6,114,017, both incorporated herein by reference, exemplify direct spinning processes practicable in support of the present invention. Multi-component filament spinning with integrated division into nano-denier filaments can be practiced in accordance with the teachings of U.S. Pat. No. 5,225,018 and U.S. Pat. No. 5,783,503, both incorporated herein by reference.

Staple fibers can be formed by spinning a continuous tow of filaments as formed from a spinning side wherein a modular die of the present invention is utilized. The continuous tow of filaments can be treated with various performance modifying topical agents and/or imparted with a crimp, and then cut into finite fiber lengths.

Staple fibers used to form nonwoven fabrics begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric desired. The fibrous batt is integrated into a nonwoven fabric by application of suitable bonding means, including, but not limited to, use of adhesive binders, thermobonding by calender or through-air oven, and hydroentanglement.

Optionally, the continuous extruded tow can be bundled, wrapped, twisted or braided into constructs of various dimension. For example small bundles or twists can be formed into yarns used in the manufacture of woven and knit textiles. Multiple small bundles or twists can be subsequently integrated with other bundles or twists to form ropes of increasing physical capacity.

The production of conventional textile fabrics is known to be a complex, multi-step process. The production of staple fiber yarns involves the carding of the fibers to provide feedstock for a roving machine, which twists the bundled fibers into a roving yarn. Alternately, continuous filaments are formed into bundle known as a tow, the tow then serving as a component of the roving yarn. Spinning machines blend multiple roving yarns into yarns that are suitable for the weaving of cloth. A first subset of weaving yarns is transferred to a warp beam, which, in turn, contains the machine direction yarns, which will then feed into a loom. A second subset of weaving yarns supply the weft or fill yarns which are the cross direction threads in a sheet of cloth. Currently, commercial high-speed looms operate at a speed of 1000-1500 picks per minute, whereby each pick is a single yarn. The weaving process produces the final fabric at manufacturing speeds of 60 inches to 200 inches per minute.

The formation of finite thickness films from thermoplastic polymers can be accomplished by use of shaped die plates that form a common extrusion gap when placed into the modular die form. Thermoplastic polymer films can be formed by either dispersion of a quantity of molten polymer into a mold having the dimensions of the desired end product, known as a cast film, or by continuously forcing the molten polymer through a die, known as an extruded film. Extruded thermoplastic polymer films can either be formed such that the film is cooled then wound as a completed material, or dispensed directly onto a secondary substrate material to form a composite material having performance of both the substrate and the film layers. Examples of suitable secondary substrate materials include other films, polymeric or metallic sheet stock, and woven or nonwoven fabrics.

Extruded films utilizing the modular die of the present invention can be formed in accordance with the following representative direct extrusion film process. Blending and dosing storage comprising at least one hopper loader for thermoplastic polymer chip and, optionally, one for pelletized additive in thermoplastic carrier resin, feed into variable speed augers. The variable speed augers transfer predetermined amounts of polymer chip and additive pellet into a mixing hopper. The mixing hopper contains a mixing propeller to further the homogeneity of the mixture. Basic volumetric systems such as that described are a minimum requirement for accurately blending the additive into the thermoplastic polymer. The polymer chip and additive pellet blend feeds into a multi-zone extruder. Upon mixing and extrusion from the multi-zone extruder, the polymer compound is conveyed via heated polymer piping through a screen changer, wherein breaker plates having different screen meshes are employed to retain solid or semi-molten polymer chips and other macroscopic debris. The mixed polymer is then fed into a melt pump, and then to a combining block. The combining block allows for multiple film layers to be extruded, the film layers being of either the same composition or fed from different systems as described above. The combining block is connected to an extrusion die, which is positioned in an overhead orientation such that molten film extrusion is deposited at a nip between a nip roll and a cast roll.

When a secondary substrate material is to receive a film layer extrusion, a secondary substrate material source is provided in roll form to a tension-controlled unwinder. The secondary substrate material is unwound and moves over the nip roll. The molten film extrusion from the extrusion die is deposited onto the secondary substrate material at the nip point between the nip roll and the cast roll to form a strong and durable carrier substrate layer. The newly formed substrate layer is then removed from the cast roll by a stripper roll and wound onto a new roll.

Breathable barrier films can be combined with the improved barrier performance imparted by combining the breathable barrier film with nano-denier continuous filaments. Monolithic films, as taught in patent number U.S. Pat. No. 6,191,211, and microporous films, as taught in patent number U.S. Pat. No. 6,264,864, both patents herein incorporated by reference, represent the mechanisms of forming such breathable barrier films.

Manufacture of nonwoven compound fabrics embodying the principles of the present invention includes the use of films, fibers and/or filaments having different composition. Differing thermoplastic polymers can be compounded with the same or different performance improvement additives. Further, fibers and/or filaments may be blended with fibers and/or filaments that have not been modified by the compounding of additives.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

1. A method of making a stack-plate comprising a plurality of single die plates oriented into face to face juxtaposition, each of said single die plates within the stack having an x-direction, a y-direction, and a z-direction, wherein said single die plates exhibit in said x-direction and y-direction to have at least 50% planar continuity of the total planar continuity.

2. A method of making a stack-plate die as in claim 1, wherein the single die plates are designed in the x-direction and y-direction to have at least 75% planar continuity of the total planar.

3. A method of making a stack-plate comprising a plurality of single die plates oriented into face to face juxtaposition, each of said single die plates within the stack having an x-direction, a y-direction, and a z-direction, said single die plates exhibit in said z-direction of the single die plates within the stack are planar in formation and designed in the z-direction to have at least 20% depth continuity of the total planar depth continuity at any given axis in the z-direction.

4. A method of making a stack-plate as in claim 3, wherein the single die plates are designed in the z-direction to have at least 35% planar continuity of the total planar continuity at any given axis in the z-direction.

5. A method of making a stack-plate as in claim 3, wherein the single die plates are designed in the z-direction to have at least 50% planar depth continuity of the total depth planar continuity at any given axis in the z-direction.

6. A method of making a stack-plate wherein the single die plates within the stack are planar in formation comprising a combined planar continuity design of at least 35% planar continuity of the total planar continuity at any given axis in either the x-direction or y-direction and at least 20% planar depth continuity of the total depth continuity at any given axis in the z-direction.

7. A method of making a stack-plate as in claim 6, wherein the single die plates are designed comprising a combined planar continuity of at least 50% planar continuity of the total planar continuity at any given axis in either the x-direction or y-direction and at least 35% planar depth continuity of the total depth continuity at any given axis in the z-direction.

8. A method of making a stack-plate die as in claim 6, wherein the single die plates are designed comprising a combined planar continuity of at least 75% planar continuity of the total planar continuity at any given axis in either the x-direction or y-direction and at least 50% planar depth continuity of the total depth continuity at any given axis in the z-direction.

9. A method of making a stack-plate die as in claim 6, wherein the single die plates are held together in the stack via compression tensioning.

10. A method of making a stack-plate die as in claim 9, wherein said compression tensioning is provided in the form of an external clamping force.

11. A method of making a stack-plate die as in claim 9, wherein said compression tensioning is provided in the form of an internal drawing force.

12. A method of making a stack-plate melt extrusion die as in claim 6, wherein the single die plates comprise guide elements for precise alignment of plates.

13. A method of making a stack-plate die as in claim 12, wherein said guide elements are alignment holes in one or more single die plates.

14. A method of making a stack-plate die as in claim 12, wherein said guide elements are projections extending from one or more single die plates.

15. A method of making a stack-plate die as in claim 12, wherein said guide holes of stacked plates are threaded onto cooled rods.

16. A method of making a stack-plate die as in claim 6, wherein said die is stacked together to comprise a vacuum slit within the stack-plate die.

17. A method of making a stack-plate die as in claim 6, wherein said stacked-plate die is used to dispense molten thermoplastics.

18. A method of making a stack-plate die as in claim 6, wherein said stacked-plate die is used to form water jets.

19. A method of making a stack-plate die as in claim 6, wherein said stacked-plate die is used to dispense adhesive.

20. A method of making a stack-plate die, wherein the stack-plate die comprises a plurality of single plates, each of said single plates comprised of at least one fluid stream channel and at least one flow channel, wherein said stream impingement angle upon flow channel is between 3° and 87°

21. A method of making a stack-plate die as in claim 20, wherein said fluid stream channel(s) have a length to diameter ratio that is greater than 1:10.

22. A method of making a stack-plate die as in claim 20, wherein said fluid stream channel(s)have a length to diameter ratio that is greater than 1:50.

23. A method of making a stack-plate die as in claim 20, wherein the fluid stream channel(s) have a length to diameter ratio that is greater than 1:100.

24. A method of making a stack-plate die as in claim 20, wherein said die comprises more than one fluid stream channel.

25. A method of making a stack-plate die as in claim 20, wherein said fluid stream channel(s) are comprised of differential pressures.

26. A method of making a stack-plate die as in claim 20, wherein said fluid stream channel(s) express differing materials.

27. A method of making a stack-plate die as in claim 20, wherein said flow channel extrudes a refractory fiber mix.

28. A method of making a stack-plate die as in claim 27, wherein said refractory fiber mix comprises ceramic fibers.

29. A method of making a stack-plate die as in claim 20, wherein said flow channel extrudes a thermoplastic polymer.

30. A method of making a stack-plate die as in claim 20, wherein said flow channel extrudes a thermoset polymer.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)
